(19) United States
(12) Patent Application Publication
(10) Pub. No.: US 2002/0035483 A1
(43) Pub. Date: Mar. 21, 2002

(54) Multiple portal distributed business/information system and method

(76) Inventor: Kirtikumar Natubhai Patel, Sugar Land, TX (US)

Correspondence Address: KIRTIKUMAR N. PATEL, 6123 WALKERS PK. DR., SUGAR LAND, TX, 77479, US

(21) Appl. No.: 09/955,330

(22) Filed: Sep. 18, 2001

Related U.S. Application Data
(60) Provisional application No. 60/233,849, filed on Sep. 20, 2000.

(51) Int. Cl. G06F 17/60

(52) U.S. Cl. 705/1

(57) ABSTRACT

A system comprising of integrated, inter-linked and/or externally-linked, distributed vertical and/or horizontal portals or combination thereof or other portals, which using the distributed and controlled portal system and environment overcomes many of the multi-faceted problems applicable to the current art/use of web/internet, intranet and other electronically addressable site(s) or portal(s). Distributed portal system provides means/solutions via distribution of functions, utilities, burdens, band-width, processes, collaborations, data-basing, data-handling, data-storing/recording/warehousing, catalogues, reverse-catalogues (hereafter called “Recats”), interfaces, automation tools, profilers, bots/ebots/ibots/crawlers, interactive connections/interfaces, user mapping and any number of practical/conceivable applications, including interactively manufactured interfaces, to be distributed among the number of portals, users, network(s) and any other systems or interfaces under the influence/supervision of a designated or proprietary/captively controlled environment or configuration of the distributed portal system. Under its supervision can provide facilities that can be used to let end-users/system(s)/application(s) interface both within and/or outside the distributed portal system.

### CROSS-REFERENCE TO RELATED APPLICATIONS

This application claims the benefit of U.S. Provisional Application No. 60/233,849 filed Sep. 20, 2000.

### BACKGROUND

Field

The general scope of this invention derives and combines from various non-analogous areas of technologies and fields, such as but not limited to computer programming methods, electronic networking, internet/network systems, commercial functions and processes, marketing strategies and methods, physical world operations, international optional functions, business processes, data handling and information technology combined into this non-obvious system creation and innovation; covering design and use of a multi-portal/multi-hub computer and internet/electronic-network implemented business/information/system utility and/or method and/or functional system/facilities embodying combinations of computers, computer systems, computer networks, internet/electronic-network portals/interfaces and user/provider portals/interfaces; and where selected, the elemental or component structure creation/construction, and design of the system, functions, programs, form, computer implemented process(es)/application(s), computer implemented business process(es) or application(s) and their assembly/design implementations, computer implemented business process(es) or system(s) or application(s) design and/or implementation and maintenance methodologies; portal function and/or functional inter-linking, portal function/functional inter-relationships and/or function/functional networking, common “engine” or modular design/implementation concept of portal facilities and functions; for purpose of but not limited to commerce and/or business process(es) and/or method and/or data handling and interchange/exchange and/or information handling ad interchange/exchange and/or transaction handling and inter-change/exchange and/or communications handling and inter-change/exchange and/or interactive facility and functions; Covers business system and broad architecture for applications created/designed to provide means of carrying out electronic commerce (e-commerce) and/or information handling and/or data handling and/or transactions via electronic-networks (e.g. but not limited to Internet) in and/or outside a system/network comprising of component(s) which is/are developed/designed/created (component-wise and system-wise) to distribute the process/functions among but not limited to a system/network or set of specifically designed or created or existing portal(s) and hub(s) which may be classified generally but not limited to as “User Portals”(including but not limited to “User Interfaces”), “Vertical Portals” and “Horizontal Portals” and their encompassing network(s)/system(s); will result in but not limited to, as in example selected here in boosted highly efficient, highly interconnected though dispersed participant participation, industry and cross-industry encompassing distributed across the network/system design/selection but focussed commerce and transactions activities.

### DESCRIPTION OF THE BACKGROUND

In the related conventional area of current internet and information/data handling network market use is made and is based on single/dense-structure portals and/or hubs applications for business sytems/processes/methods, the information handing electronic-network based (including but not limited to internet intranet, virtual private networks, extra-net, local networks, global networks—henceforth collectively called network(s)) commerce, trading and data/information handling (including but not limited to commerce/information exchanges, trading hubs, auctions, etc) is based on single/dense-structure portals and/or hubs, (i.e. current utilization is of single/dense-structure websites which provide the user interfaces for trading, commerce, information handling/communicating and transactions handling/communicating.)

Conventionally, to access various processes and options offered by the typical dense structure web-site/portal (henceforth all singly or collectively referred to as “portal” or “portals”) one practically and/or manually accesses the “portal” via browsers or “User Portals” or other electronic means or user interface(s) compatible with the networks; and where one is presented with, options to navigate to the desired subject, item, entity, area of interest or functions (henceforth which will all be referred to singly or collectively as “function” or “functions”) via navigation along branches and predominantly non coherent links presented by the single or dense-structure portal(s) starting from.

These “portals” are fixed entities and properties, electronically accessible as network locations/facilities (for example, but not limited to internet URL entities such as with but not limited to “.com”, “.net”, “.org”, “.tv”, “.co.uk” as extension suffixes to the internet domain address names) which are facilitated with user web-site facilities/interfaces by or for the use of various parties.

These “portals” are typically accessed electronically and then traversed by use of various options presented by the facility to navigate to points of desired options and interests. These “portals” are termed “Vertical Portals”.

One problem current but not limited to is that such organization of dense structured vertical portals become denser and denser with more and more features added or grafted on to encompass all pertinent activities and participants they need to cater to, resulting in cumbersome and less flexible, less fault tolerant structures, requiring bigger bandwidth high density traffic facilities and discouraging to many users as more and more layers are added on to be navigated to access desired functions and areas of interest. Further problems are magnified when local content, for example but not limited to, different languages, local criteria's, local regulations, possible local taxes, local filters and such need to be implemented within or grafted/programmed on to the dense structure portal.

As a solution, we are providing means of dispersing/distributing the implementation, functions, features and reducing complexity inherent in dense structure portals, by distributing them amongst a generally systematically designed and constructed network/system of multiple portals, which will overcome many of such problems as those of but not limited to traffic, bandwidth, dense structures, local content, system oriented maintenance, coherent process and/or business handling systems and designs, and in many instances provide additional flexibility and facilities/functions.

According to this invention, is provided a computer and internet or other electronic-network implemented business system and/or data handling system and/or method using multi-portal (multiple portal) system of “vertical” portals and/or “horizontal” portals created and Designed for integration and/or implementation into a business and/or data/information handling system;

With user and internet/electronic-network functional facilities embodying any of various combination of computers, computer systems, computer networks, internet/electronic-network portals/interfaces and user/provider portals/interfaces there is provided a business system and/or method for process components and/or business process and/or electronic commerce system architecture and/or network architecture and/or “eCommerce” structure and form, to overcome many problems of the densely structured portals, by providing system and/or methodology for design/configuration/assembly of component portals and/or network architecture means by which system component implementations can be/is/are integrated into a coherent network/system of portals and functions for carrying out but not limited to chain management (SCM)/client relation management (CRM or eCRM)/wide-spread asset and operations management, and other process processes;

As a part and/or component part of and/or business method/process and/or system the design and/or creation process of portal name structures, portal URL and addresses and implementation is, though not limited by, one key part and is/are conceptualized, designed, created, structured and financially owned/purchased/leased entities/properties to be compatible/logical and/or targeted for integration into a selected/designed/existing/available network(s), by use of our system and where selected our methodology;

The system and/or network is designed to fit whichever purpose, of such as but not limited to business/trade/commerce/information-handling/communications/transactions/supply chain management (SCM)/client relation management (CRM or eCRM)/other process processes, is selected/designed by using these component portals as distributed, networked portals or as options/links provided via other portals;

By design, functionality provided by means of distributed portal system(s) provide means and ease of design of accessing manually or automatically the portal facilities by computer programs designed and implemented by one skilled in designing such computer programs or routines,

The portals are to be provided/furnished and function enriched with computer program/programs which may be carried out by skilled programmers or made available by/as commercial products by others to carry out such as, but not limited to business/trade/commerce/information-handling/communications/transactions/supply chain management (SCM)/client relation management (CRM or eCRM)other process functions/processes;

The architecture of the component portals and network is designed so that it presents a means or provides ease to integrate Vertical Portals (VP's) within themselves as well as integrate VP's with Horizontal Portals (HP's) which can/are integrated within themselves and/or with the network of Vertical Portals and Horizontal Portals;

The system is provided for it to be configured/designed so that component parts, Portals and/or the network can be/are active at any time;

One business process and/or method of this invention is to design/configure the portals, in, but not limited to, modular and/or selective programming/designing method(s) by prototyping/designing/assembling one or several programs or suites of programs in to modules or use as modules to carry out such as but not limited to business/trade/commerce/information-handling/communications/transactions/supply chain management (SCM)/client relation management (CRM or eCRM)/marketing/other process processes, and then optionally using the assembly of such module/modules (henceforth called “engines”) as prototype base design to be installed/implemented/grafted/modified at/for any/all of the portals in/linked to the network (and at which point we can designate the portal(s) so implemented from the prototype or selective programming, for description purpose, as Stage 1 Hub(s)); utilizing skilled personnel. Methods of program designs/implementations/applications or modular assemblies for the engines would be that of but not limited to Object Oriented Programming and/or Modeling methods, in order to coherently and with ease maintain and implement features/functions of each Portal or Hub either individually or collectively;

As part of this business system or process model Stage 1 Hubs are now individually or collectively further refined or enhanced, to be carried out by ones available and skilled in providing the expertise, to include specific functionalit(ies) or local/global contents by adding such facilities as for example, but not limited to, local/global language(s), local/global regulations, local/global transaction aids, local manufacturers, local transport systems/companies, etc.;

The ports will be provided with functionality(ies) and/or computer programs by design by ones skilled in it or by program products provided by others so that the portals inter-link with either all/selective/specific portals in the as well as outside the network to actively provide but not limited to polling/searching/posting/decision-actions/options/other processes to carry out such activities but not limited to as commerce, trading, data handling and system(s);

A global and/or gateway portal(s) can be used where the portals in the network are made accessible via that portal or other optional user interface(s) and/or User Portals, e.g. but not limited to for a gateway portal a collection/selection of all/specific local/global portals can be provided in that or selected portal to be accessible by a user;

In any case all/any portal part of the system or accessing the system is/can be optionally designed as gateway portals.

These portals designed for a or a part of but not limited to coherent system(s) and/or distributed into a system or processes or network and between which processes and functions are distributed; and as options individually/collectively enriched in the but not limited to various necessary functions (for example, but not limited to local country regulations, local/international languages, demographics related functions, geographical related function, infrastructure related functions, logistics related functions, and government to government functions, etc.) which can be individually/collectively designed/grafted into the distributed portals; Carried out by ones skilled in it.

The components, system and/or network of portals using and configuring according to the system or design/methodology/process/system of this invention imparts a dynamic operating commercial/informational functionality/machinery that spans/operates over/among designated/aimed areas by the aimed design of the components and the system/network design (for example but not limited to worldwide spanning network for trading purposes);

And according to the present invention (including as part and encompassing of design/creation/assembly features of the example of eChemXS Model included herein) there is provided a business system and/or method/process and/or architecture/design which comprises of methodical and/or systematic design(s)/creation(s) of component electronic-network (for example including, but not limited to internet, virtual private networks, intranet, etc.) based, including but not limited to, “portal(s)” or “hub(s)” or “domain(s)”(as physical entities embodied as property that can be owned/transacted) by use of systematic/methodical design/creation of structure including the use of prefix and/or suffix in conjunction with a selected core name/label (for example but not limited to, as related areas/aims of interest, such as countries, regions, provinces, categories, classifications, etc.) and or further owned/purchased/leased of such; which are optionally further methodically provided/designed with programs/provisions to provide all required functionality(ies) to the portals and inter-link between, but not limited to, the above designed portals for information and/or data transmission/exchange/transactions and handling, between, for example but not limited to each other, whereby many functions requiring but not limited to coherent information/data process networking are enriched by further individually/collectively electronic/computer programming and methodologies (including but not limited to use of “Object Oriented” programming and modeling techniques; in effect by distributing into separate portals and inter-linking distribute the complexity of functions or facilities or purpose of, including but not limited to trading operations and/or transactions/transactions handling and/or information/information handling and/or data/data handling;

Further as part of the business system and/or process the portals are optionally designed and categorized as “Vertical Portals or Hubs” and “Horizontal Portals or Hubs” and which are optionally provided means of integration into a coherent/coordinated (information exchange/handling)(data exchange/handling)/(transaction exchange/handling) business system/network; all this is including installations and/or functions relevant to the participants, optionally along with their business operations/presence lodged/installed/implemented within the portal, as one alternative but not limited to, in the form of participant operated/maintained facility within the portal, or facilities towards or for active interfaces to other users/participants/portals and/or functions; including but not limited to active catalogs, menus, directory functions, etc. to facilitate business; including interfaces/links/facility allowing access to others, to them or their offers/facilities/information; including implementation of their electronic store fronts with any/all the relevant functions, including but not limited to, within or by means of the portals (or hubs).

Though not limited to, some of the general areas of the preset invention considered above and herein, include (but without void any other implicated areas):

It is part of and is considered for the present invention to provide a system, structure and architecture and/or method for creating, building and utilizing a multiple portal system and utility for commerce/business/information/data handling systems that by spreading and distributing functionality(ies) and loads overcome inherent problems of: cumbersome and less flexible, less fault tolerant structures, that are bigger bandwidth high density traffic facilities and which encounter magnified problems when local content, for example but not limited to, different languages, local criteria's, local regulations, possible local taxes, local filters and such need to be implemented within or grafted/programmed on to the dense structure portals;

It is part of and is considered for the present invention to provide a system, structure and architecture and/or method for creating, building and utilizing a multiple portal system and utility for commerce/business/information/data handling systems;

It is part of and is considered for the present invention to provide a system, structure and architecture and/or method and/or means for creating and integrating a network of portals that integrate vertical and horizontal portals, and their functions and networking within the system and with other systems;

It is part of and is considered for the present invention to provide a method of creating structure(s) for component portals, including, but not limited to, basic/elemental creation, design, incorporating and commercial establishment of the portals/portal-entities;

It is part of and is considered for the present system to provide an environment and/or means for design or assembly or building of components that can be easily modified or expanded to fit the needs of a particular environment.

It is part of and is considered for the present invention to provide a system and method that provide, and can easily maintain, the portals with functions and/or user interfaces.

It is part of and is considered for the present invention to provide a method of implementation/insantation of system and/or system components, and method(s) that reduce development and maintenance cycle time.

It is part of and is considered for the present invention to provide a function and system means that can support existing systems having legacy applications, or proposed/projected systems and applications.

It is part of and is considered for the present invention to provide a system and method that can support expanding or shrinking needs or demands of the portals.

It is part of and is considered for the present invention to provide a system and method that can support and distribute loads of commerce/data/information among the network of portals.

It is part of and is considered for the present invention to provide a system and method that can support and distribute traffic and network bandwidth requirements among the network of portals.

It is part of and is considered for the present invention to provide a system and method that can provide eased environment for commerce/data-interchange/information-exchange by any/all size of commercial or other entities utilizing the network of portals.

It is part of and is considered for the present invention to provide a system and method that can support integration of complete chains of commerce/data-interchange/information-exchange/transactions/data-handling by means of the network of portals.

It is part of and is considered for the present invention to provide a system, structure and architecture and/or method and means for providing fault tolerant system utilizing a multi-portal system;

It is part of and is considered for the present invention to provide a system, structure and architecture and/or method and/or means for providing integration and/or utility for material/energy/environmental-credits/information/data handling/managing systems; and/or integration into corporate or corporate-wide system(s).

It is part of and is considered for the present invention to provide a system, structure and architecture and/or method and means for providing utility/facility to organizations with, but not limited to, wide-spread branches, divisions, plants, facilities, assets, operations at any level that can benefit by means of the multi-portal system herein;

### SUMMARY

Current problems of conventional portals and hubs, but not limited to, is that such portal designs and organizations are dense structured portals which become denser and denser with more and more features added or grafted on to encompass all pertinent functions and users and participants they need to cater to. This resulting in cumbersome and less flexible, less fault tolerant structures, difficult to secure systems, requiring larger bandwidths and high density traffic facilities, and discouraging to many users as more and more layers are added on to be navigated to access desired functions and areas of interest. Further problems are magnified when local content for example but not limited to, different languages, local criteria's, local regulations, possible local taxes, local filters and such need to be implemented within or grafted/programmed on to the dense structure portal.

As a solution, we are providing means of dispersing/distributing the implementation, functions, features and reducing complexity inherent in dense structure portals, by distributing them amongst a generally systematically designed and constructed network/system of multiple portals, which will overcome many of such problems as those of but not limited to traffic, bandwidth, dense structures, security, local content, system oriented maintenance, coherent process and/or business handling systems and designs, and in many instances provide additional flexibility and facilities/functions.

Herein this invention generally, is provided a computer and internet or other electronic-network implemented business system and/or data handling system and/or method using multi-portal (multiple portal) system of “vertical” portals and/or “horizontal” portals and/or user portals/interfaces provided or created and designed for integration and/or implementation into a business and/or data/information handling system(s);

It covers though not limited to, key concepts and implementations of designing the elements of the system portals, including URL structure and/or portal entities, general integration via electronic/information networking of portals (including but not limited to vertical and horizontal portals, user interface(s), user portals, etc.), distributing respective loads to appropriate portals in the system, general methodology for portal function and/or engine designs and their core implementations on/within other portals (including within the system and outside to other systems/facilities), general means for functional enhancement of the core designs of the portals. The system and/or network is generally designed to fit various areas of utility of such as but not limited to business networking and operations, trade system networking and operations, commerce networking and operations, information system networking and operations, transactions systems and operations, supply chain management (SCM) systems and operations, client relation management (CRM or eCRM) systems and operations, production/plant systems and operations, and various general process systems and operations, using this system of component portals/hubs/stations as distributed, networked portals or as options/links provided via other portals; System includes means for providing for legacy and existing or forecasted/future systems to inter-link/cross-link and generally participate in the networked operations. System generally covers a system that provides, but is not limited to, cross-industry, cross-country, cross-regions, cross-subject-areas, cross-platform, cross-linking operations/functions and functional platforms with/without networking.

Included in overcoming many problems of the densely structured portals, is by providing system and/or methodology for design/configuration/assembly/architecture of component portals and/or network architecture means by which, generally in the areas of, system function-loads, user/data traffic, bandwidth, maintenance, security, local content, programming, rolling out, implementations, and other necessary and obvious functions can be distributed, dispersed, and/or phased by use of this system invention.

By design, functionality provided by means of distributed portal system(s) provide means and ease of providing design of accessing manually or automatically the portal facilities by computers or computer programs designed and implemented by one skilled in programming and implementing such computer programs, processes or routines.

Invention includes but not limited to, generally, installations and/or functions relevant to the participants, optionally along with their business operations/presence lodged/installed/implemented within the portal, as one alternative but not limited to, in the form of participant operated/maintained facility within the portal, or facilities towards or for active interfaces to other users/participants/portals and/or functions; including but not limited to active catalogs, means, functions to facilitate business; including interfaces/links/facility allowing access to others, to them or their offers/facilities/information, including implementation of their electronic store fronts with any/all the relevant functions, including but not limited to, within or by means of the portals (or hubs) and the multi-portal system

### DRAWINGS

In most instance are either drawn and made obvious to one skilled in it and as such are self explanatory in the functionality(ies) or mechanics encompassed therein:

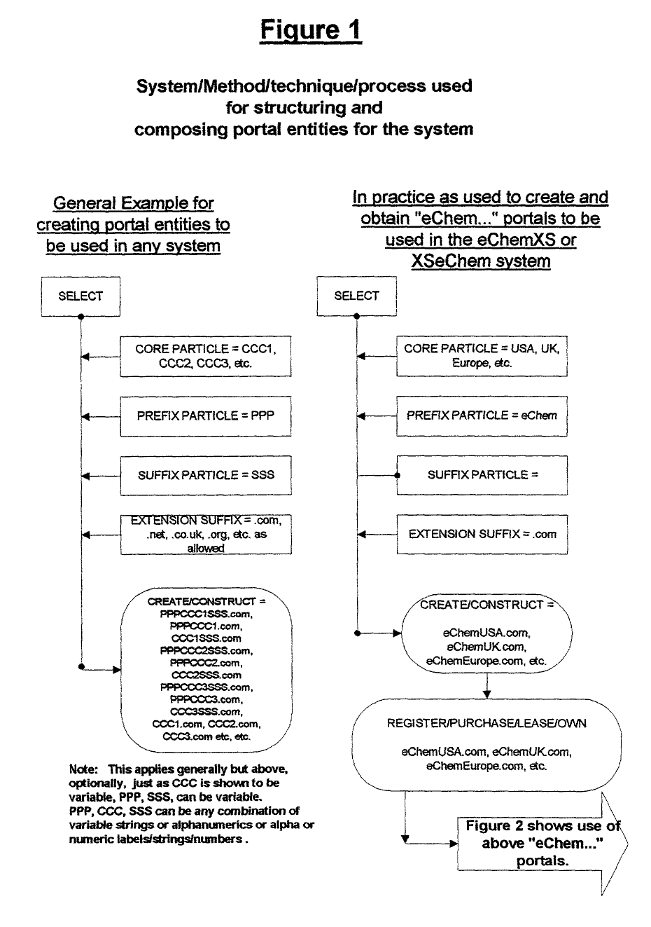

1) FIG. 1 shows how but not limited to a component portal is conceptualized, designed, structured and embodied in a purchasable/lease-able/own-able entity or property, with example of such created portals which are in practice currently owned.

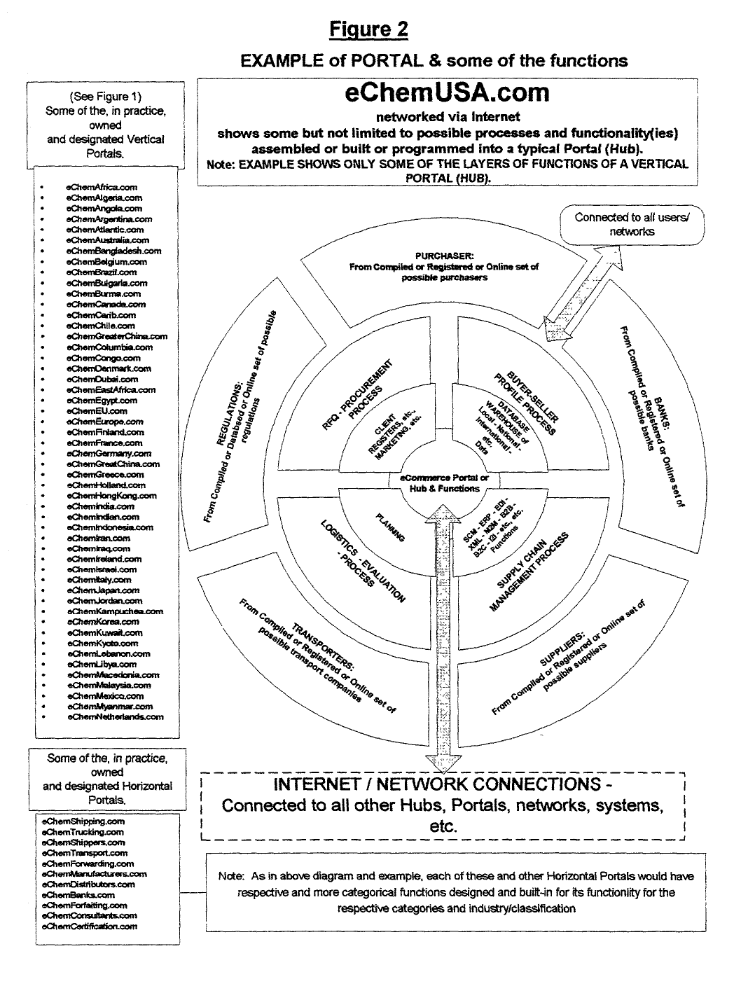

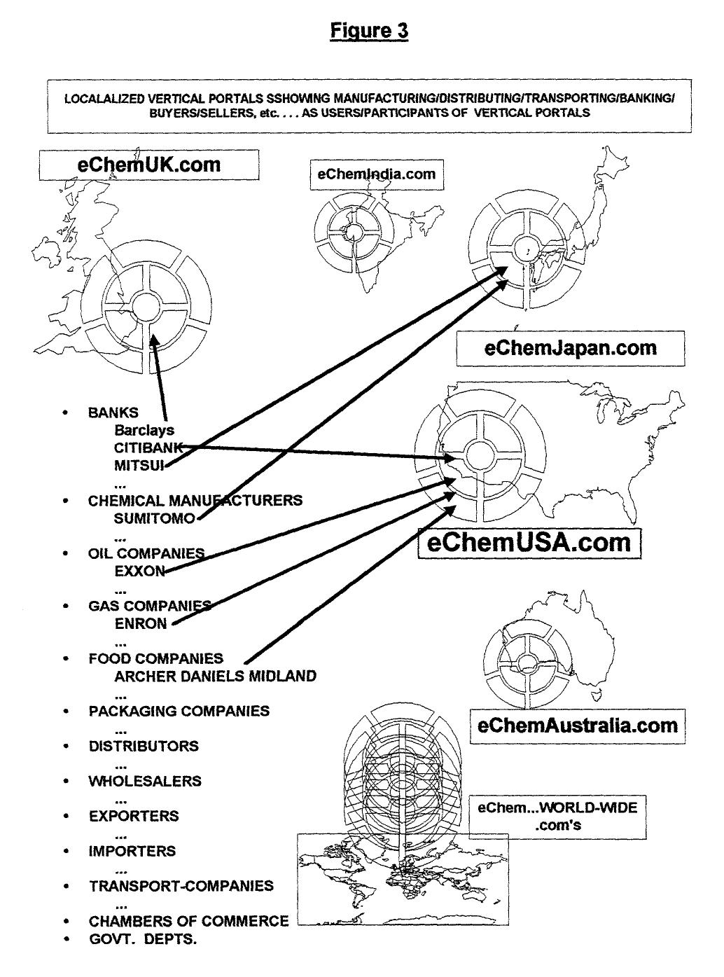

2) FIG. 2 shows as an example, with partially listed functions of a portal show the functionalit(ies) of as assembled/built/programmed into a typical Vertical Portal (Hub) and/or Horizontal Portal (Hub), by using readily available skills and technology; Including, for example, but not limited to some of commerce process(es)/functions shown as processes/functionality(ies) of commercial value that are to be built into such hubs.

3) FIG. 3 Shows example of but not limited to commercial entities that would be functionally installed/linked/ported/data-based via user interfaces/user portals/electronic links into various Vertical Portals (Hubs).

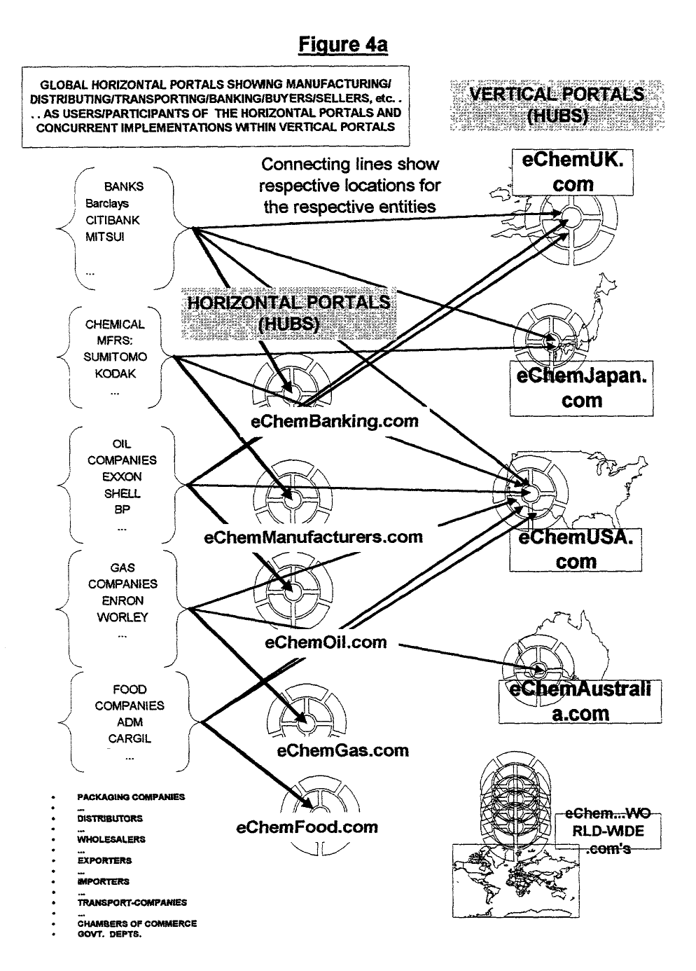

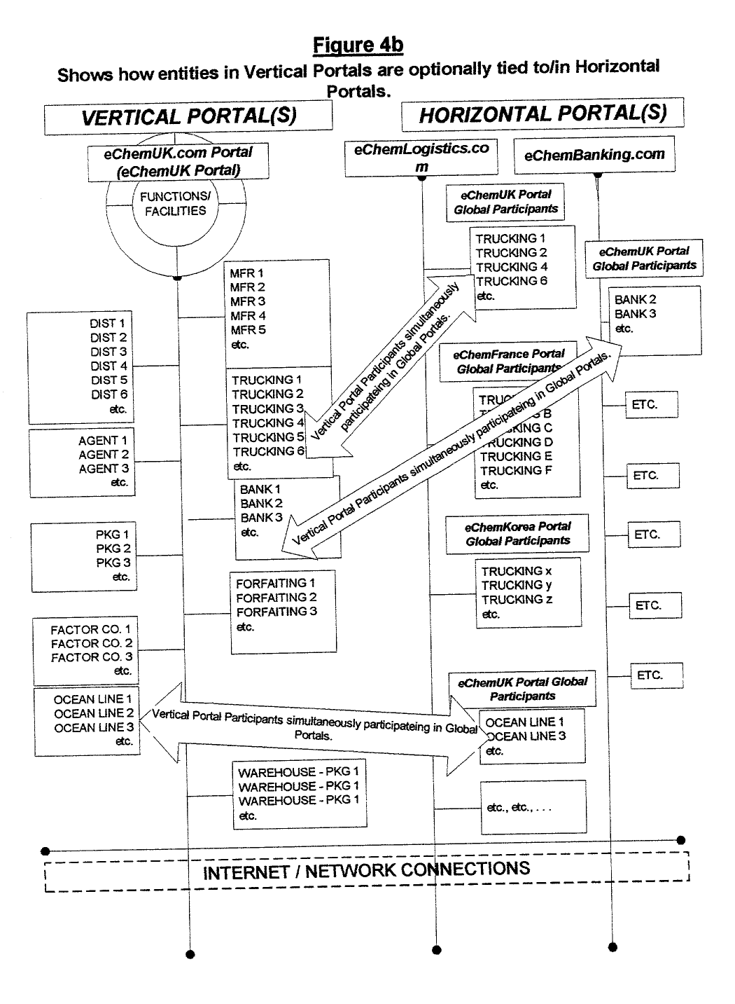

4) FIG. 4a Shows examples of but not limited to how commercial entities that would be functionally installed/linked/ported/lodged via user interfaces/user portals/electronic links into various global Horizontal Portals (Hubs), are also in the Vertical Portals (Hubs) as an inherent part of the system;

5) FIG. 4b Different view to (FIG. 4a) shows but not limited to, how commercial entities that would be functionally installed/linked/ported/lodged via user interfaces/user portals/electronic links into various Vertical Portals (Hubs) are also optionally part of Horizontal Portals (Hubs);

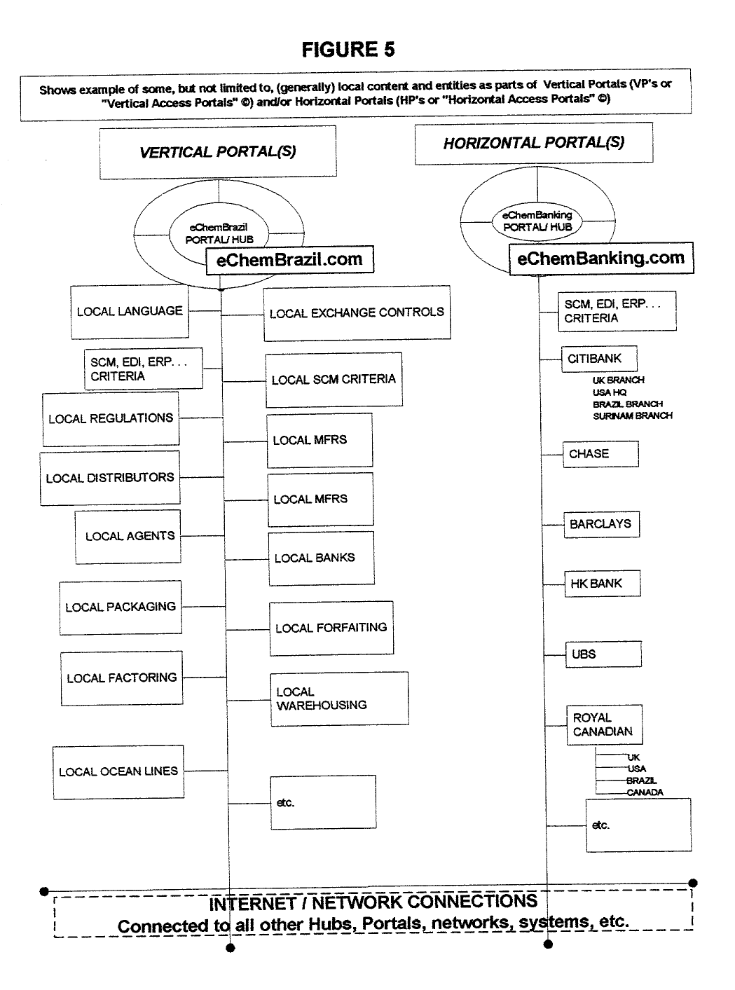

6) FIG. 5 shows example of some, but not limited to, (generally) local content and entities as parts of Vertical Portals (VP's or “Vertical Access Portals”©) and/or Horizontal Portals (HP's or “Horizontal Access Portals”©)

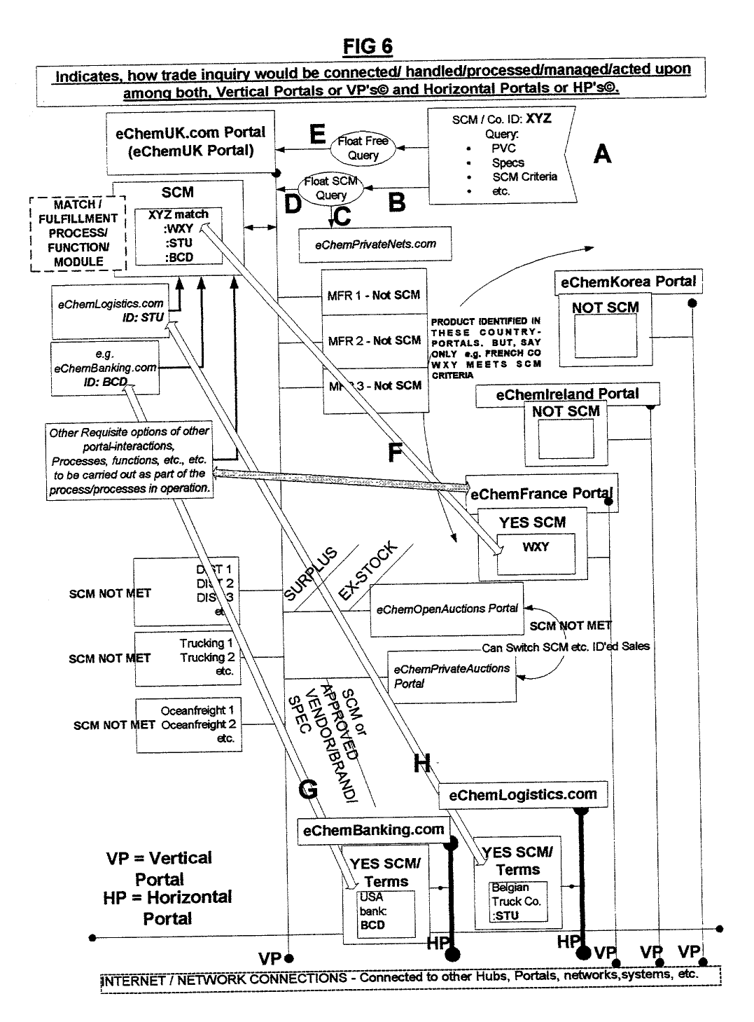

7) FIG. 6 shows example of, but not limited to, how, by indications, a trade inquiry would be handled/processed/managed/acted upon between VP's© and HP's©.

### DETAILED DESCRIPTION

One area of application of the invention, but not limited to the application will now be described by way of narrative, references and reference to in practically owned components as component part of the trading system model for, for example, Chemical Industry relevant, as described in the accompanying drawings as above in which:

As an example, this model is applied to but not limited to international trade/function facilities for the chemicals industry and its supporting industry (at all levels) and it is shown in that context here as and assuming how one who is skilled in the arts can go about to create/assemble all the components and implement such a network of portals and design or use available technology and techniques to implement any/all functionality(ies) at each portal and within the network as a whole. This system is applicable generally in many areas and can be applied to various areas/systems/industries as briefly listed below; A skilled person would be able to configure/design the components, the computer/electronic-medium and network using such technologies as computer programming, internet web-pages, internet web-sites, database(s), information handling software engine(s), transaction handling (software) engine(s), transaction handling techniques and/or technologies and/or commercial program/software products to give the requisite functionality(ies), and, where applicable, inter relate/inter-link: computer(s) with other elements of the information handling networks to yield the desired functions from the invention.

Further, as part of this one demonstration, to show practical component part of this business system invention we have in practice used the address and naming techniques to practically and functionally, create and own portals which we own and form, what we have given the terms of Vertical Local Portals ©(VLP ©) or Vertical Local Hub-Portals ©(VLHP ©) or Vertical Local Hubs ©(VLH ©) or Vertical Hubs ©(VH ©) or Vertical Portals (VP ©) and Horizontal Global Portals ©(HGP ©) or Horizontal Global Hub-Portals ©(HGHP ©) or Horizontal Global Hubs ©(HGH ©) or Horizontal Hubs (HH ©) or Horizontal Portals (HP ©) as practical part of our invention.

The practical design and application of this innovation and invention solves some of the problems in the industry which uses bulletin board or dense-structure portal approach providing database functions as exchanges, and solves many other practical problems, some pointed above herein, by design and provision of this multi-portal network architecture, multi-portal networking model, design process/methodology for multi-portal component creation, design structuring, naming and addressing techniques, and model for but not limited to integration and implementation of various business processes (e.g. but not limited to various business transactions such as local content, request for quotations (RFQ), Purchase Orders (PO), various procurement functions, planning financial and such transactions, supply chain management (SCM), Client relations management (CRM), Transactions Handling, Optimizations, marketing and, functions and function handling computer program platforms and engines either by design or by use of commercially available products) within the local or global networked portals. Further, the Vertical Portals are cross-referenced and/or linked/integrated with Horizontal Portals (portals that are designed to provide functions classified by categories e.g. transportation companies, banks, manufacturers, products, etc.) and vise versa. The example here will be shown and explained as/along with a narrative and description of the components and model that we own along with its context in various areas.

Example of one system and instance, from those possible from the invention, as it is created, owned and generally described:

Here is an innovative, but a pragmatic, practical and game changing eCommerce market place business process model that encompasses and brings some or most of (1) traditional levels of user interaction, (2) user comfort, (3) CRM/eCRM, (4) SCM, (5) simplicity, (6) agility, (7) robustness and (8) security to participants in this instance, a neutral free market place.

As an innovation this is a game-changing model with “Global Localization” to each country or area of interest, combining natural and traditional levels of CRM and e-CRMK tapping potentials of specific/open SCM, supporting neutral markets, providing private markets, potentials of open SCM networking, auctions, reverse auctions, etc.

An agile, dynamic, reactive and proactive model is presented, instead of the one portal “semi-static” bill board or bulletin board models. Plus embracing simplicity and robustness for rapid successful deployment.

The first business process step is to design, structure, create and/or register/purchase/lease set of network based portals which typically are stored and recognized as name and physically computer recognizable electronically and commercially lodged addresses.

This is a Multi-Portal Value-Hub Model combining cross-country, cross-industry, cross-areas of interest and international eCommerce at the same time, which is integrated from its users at the lowest or smallest corporations to its top line industry corporations.

Possible use of rule based technology with Object Oriented Design methodology and process is one key to rapid implementation, deployment, on the fly growth, and maintenance. Unlike with dense-structure portals, bandwidth, and traffic should not be big problems due to the dispersion of traffic provided by dispersion of portals and only essential traffic to portals of interest or correct fit.

Though not limited to WAP and other wireless technology and messaging technology, integration at the outset, means by which the model provides machinery and decision support by human counterparts in a “live” 7 days a week and 24 hours a day supporting system and can operate on the fly.

All the required skills and components to implement the complete invention are readily available, and can be readily utilized to obtain full benefits of the invention.

There is immense commercial potential to be derived by implementing this invention with all rapidity. The eCommerce integration being made available here, means grassroots level corporations to the top-flight SCM adept corporations, would be utilizing this invention.

What does the system and/or application do for them, is, additionally and not limited to, it provides a means of a innovative network means to the ultimate market access and utility down to the country and base level of industry and traditional levels of possible interaction and users/participants feel as if the function and utility is carried out at the local (e.g. regional, national, provincial) levels; a tremendous boost to marketing efforts and results;. eCommerce reports report that majority of even US and western nation based smaller corporations do not yet utilize internet in their commerce, besides emails, because of the difficulties and user resistance inherent/related in dense structure portals. Our model should make things perceptually and organizationally simpler and inviting to even the less sophisticated and computer integrated participants within the industries.

It is a technology that solves a critical problem and/or one that excels competing technologies in a novel way.

Calling this, a “eChemXS” or “XSeChem” Model/System/Process that is broadly designed to cover the chemicals manufacturing, consuming and related/supporting industries.

A more detailed insight of the model is demonstrated in the diagrams presented. Essentially, the model facilitates all/most desired functions practiced/desired/designed in the industry via using both Vertical Portals (“eCountry Ports” or “Country Hub-Portal”) and Horizontal Portals (categories such as world banks, shipping lines, category or class of product manufacturers, etc.) and providing means of coherence and integration.

The eChemXS Model Design, Engineering and Deployment

To start adding functions to the portals, though not limited to but as an example, one main Hub Portal or portal is designed/facilitated with to provide User Interfaces, databases, function and processes, “pipelines” and connections/interconnections; not limited to but, is designed/assembled or configured in similar fashion and analogy to an “object Class” in Object Oriented Programming(OOP) methodology. This will form the prototype or core “engine” or “hub-Engine”. In terms of OOP this will be “installed” or copied to all hubs, as “object” hub-Portals.

Though not limited to but for example:

Each Country (say) hub-Portal or portal can then be augmented/populated/modified with all the necessary local/not-local/desired, but not limited to requirements/information/regulations/data/functions, etc.; interactive templates for, local languages, registers) and registry of local entities/partners, register of local infrastructure and support facilities (Gov. etc.), interchangeable/convertible English-local-language interfaces (e.g. standardized and auto translate-able templates for forms, procedures, regulations, etc.), etc. essential to the eCommerce or selected industry/area and functions.

Vertical (Local) Portals (VLP's/VP's)

Using this methodology/technique/process, in any order and/or combination, as shown in FIG. 1, but not limited to, conceptualize, design, create and/or structure and embody portal names in a purchasable/lease-able/own-able entity and property in similar way to those in practice created portals which are currently owned to fit this model.

Methodology/technique/process used for is but not limited to is as follows (in any order):

See FIG. 1.

1. Select a Country/Category/Class/entity entity or label(s) (say, e.g. CCC, henceforth called/termed a core “particle”) And/or

2. Select/create a prefix(es) entity or label(s) (say, e.g. PPP, henceforth called/termed a prefix “particle”). And/or

3. Select/create a suffix(es) entity or label(s) (say, e.g. SSS, henceforth called/termed a suffix “particle”) And/or

4. Select recognized or appropriate network related extension suffix(es), entity(ies) or label, henceforth called “extension”(say but not limited to, e.g. .com, .net, .co.uk, .tv, etc.)

Next step is to create but not limited to, a set of portals using above combination of any/select “particles” and “extensions” in a format which is aimed for or compatible with the network to be assembled/designed/desired, e.g.:

PPPCCC.com or CCCSSS.com or CCCPPP.com or SSSCCC.com or PPPSSS.com or etc., (e.g. in this example for chemicals industry business model, prefix selected is eChem and core particles such as country/category labels of UK, USA, Europe, Banking, Logistics, Distributors, etc.)

In our example here these are set up, but not limited to, as “eChemCountry.com”(PPPCCC.com) as Vertical Portals for each country/region, e.g. eChemUK.com, eChemUSA.com, eChemEurope.com, etc.; and Horizontal Portals are designated as but not limited to as “eChemCategory.com”(PPPCCC.com), e.g. eChemShipping.com, eChemFunding.com, eChemBanking.com, eChemForfaiting.com, etc.

Then starting with but not limited to, by prototyping/assembling/designing one operating hub/portal with all requisite programs/program suites/program modules/software engines/functions to create a prototype Hub-Portal or Portal engine (“P engine”©) and then copying the P engine to select/individual/collective set of portals followed by populating/augmenting/modifying each selected hub or portal with local/global functionality(ies) utilizing necessary/potential/available/designed program/data/functions.

Optionally, copying of P engines to the portals can be carried out after it has been modified/augmented/function-readied for the select/individual/collective set of portals.

One item and function designed into this model is a register/facility and/or database of all/willing participants/clients/customers/users participating or accessible to participating in this business/commerce process/model. This is part and option of the general model too.

To demonstrate the practical functionality or machinery herein designed, but not limited to one particular action/process, as shown in FIG. 6:

A chemical company XYZ in UK (A), with a portal presence/functions provided for, or accessing within eChemUK.com portal, floats/sends an enquiry via eChemUK.com a internet hub, for 40 ft FCL of PVC it desires. Enquiry moves say but not limited to, into three-pronged enquiry “float”. All communications are considered obvious and understood, via internet and/or other electronic network(s).

1. One float A), with, but not limited to, SCM (Supply Chain Management) criteria, splits into two (C and D) with one (C) branching and polling/posting within Private Networked area(s) of established/set up with current SCM Partners

2. And, optionally, second (D) branches off with the SCM criteria, and heads into open world market hubs (including Vertical Ports and Horizontal Portals) with SCM criteria.

3. Third float (E), optionally or concurrently, goes into the free market to all worldwide hubs without SCM criteria, say, (including Vertical Portals and Horizontal Portals).

4. Etc.

Say, now, system automatically/manually identifies, various possibilities of active manufacturers, distributors, trucking companies, inspection-test lab companies, and auctions, and such, that meet the validation criteria and other specs, logistics, or availability s. However, on polling/feedback various SCM options (including UK) are presented and though they are viable sources, do not meet all SCM criteria's, however, say float (D) in the open market identifies (F) a completely feasible SCM source-criteria from a French supplier WXY within the eChemFrance.com portal.

TWO Vertical Local Portals (VP) (relating UK & France) come into play out of polling so many VP's on the worldwide Global system in a dispersed traffic pattern reducing traffic which would otherwise be high on a dense type of portal design.

Here for example, say, SCM criteria did not identify any UK or French bank or trucking/shipping (Logistics) companies to part-take in this transaction, as identifiable/compatible SCM partners/companies and, as at, say but not limited to in same time period, from polling/posting within the Horizontal Global hub-Portals (eChemBanking and eChemLogistics) a bank (G) and a trucking company (H) prove compatible to SCM criteria's and so combining,

Horizontal Global Portals (HGP's/HP's);

These portals are designed/created and set up as category/classification or function/sector portals, but not limited to, and as such most likely are part of the VLPs too (See for idea FIG. 4b) (note: In similar fashion the enquiry has options to poll/post within a HGP of eChemPVC.com or eChemChemicals.com, for the same query with obvious analogous interconnections/functions within/to the system.)

Further, as shown in FIG. 6.

A SCM compatible financial partner/bank (BCD) based in USA is identified (G), with the query and is part of HP as eChemBanking.com.

[It is also a HP based eChemBanking.com and VP based eChemUSA.com (not shown) participant]

A SCM logistics partner identified (H), a trucking/forwarding company (STU) is based in Belgium—is identified (H), with the query and is part of HP as eChemLogistics.com.

[It is also a HGP eChemLogistics and VLP eChemBelgium.com (not shown) participant]

The rest of the commercial actions, functions and processes are can be extrapolated similarily.

Some Features of the Model

eChemXS Model as modeled will be readily producible with all the tools, products and skills readily available that go into its design. It is robust and flexible in its, but not limited to, creation, implementation, maintenance, and its commercial functionality. Some of the features of the business process, but not limited to, of this invention will include:

1. As the globe turns various country portals will be “live” along with the local commerce and infrastructure (banks, trucks, ports, etc.), while sill being able to tap into the global commerce network. WAP, GSM/SMS, wireless facility communications will keep the system connected, on the wire and on-line for business, all the time.

2. Facility is provided for Virtual Private Networks designed and assembled as part of this process.

3. Private partner/support or group networks, for SCM, Logistics, other functions, etc. is part of the model.

4. Open SCM broadcast or directed function facilities.

5. Pseudo-SCM facilities such as but not limited to partial and/or SCM compatible but, optionally, not part of existing SCM partners.

6. Private SCM facilities wherein but not limited to established SCM partners.

7. Open Market facilities wherein but not limited to open queries are communicated.

8. Open Auctions, with SCM identified offer matches are switch-able to

9. Private Auction areas whereby SCM or such optional criteria's are acted/provided

10. Futures trading facility and functions.

11. “Live” or interactive (multimedia, video, audio, interfaces) negotiation/fulfilling/dealing portals, templates, and tools are provided.

12. All the service facilities for WAP, wireless technologies, banks, funds, etc via HGP or VLP or combinations thereof are implementations of the model and system.

13. As mentioned previously, some of the other areas applicable to the invention along with other necessary business processes and facilities designed/available for application of this business system/process model are generally applicable to, but not limited to:

Manufacturing Industries

Trade and/or Exchange systems

Petroleum

Energy

Health care

Pharmaceutical

Transport

Automotive

Chemical (covered in the above example)

Retail

Information Handling/Systems

Data Warehousing/systems

Data Handling/Systems and Others

The features and configurations of the invention are essentially embodied (in the example above) and include options for following function implementations at the portals, but not limited to, options exercisable in the following business processes/functions:

Consumption and Planning

Supply Chain Management

Electronic DATA Interchange

Electronic data conversions to/from Legacy systems/formats

Data security programs/protocols

Data templates and/or formulations

Data backups and for storage and/or data transmissions/handling

Inventory Management

Information Systems

Invoice Verifications

Purchasing

Warehouse/Inventory Management

Basic Business Functions

Billing

Payments

Sales Support

Foreign or inter-territorial Trades

Information Systems

Master data or Data Warehousing

Shipping

Sales

Transportation

Financial Accounting

Assets Accounting

Accounts Payable

Accounts Receivable

General Ledger Accounting

Consolidation

Special Purchase Ledgers

Costing:

Activity Based Costing

Overhead Cost Control

Sales and Profitability Analysis

Product Cost Controlling

Enterprise Controlling:

Executive Information System

Management Consolidation

Profit Center Accounting

Modules and/or submodules/processes including:

Assembly Orders

Basic data systems

Capacity Requirement Planning

Information Systems

Just-in-Time Concepts

Master Planning

Materials Requirement Planning

Plant Data Collection

Production Planning (e.g. for Process Industries, manufacturing etc.)

Repetitive/Continuous Manufacturing

Production Orders

Sales and Operation Planning

Automatic Logging/Managing systems (e.g. but not limited to, barcode and inventory systems, plant monitor and control systems, etc.)

And wide-area organizational operations

In essence, including above description, a “portal” may comprise of any of electronically addressable or recognizable or navigable areas or locations or domains within the internet, extra-net, intranet or other electronic networks or interfaces/networks such as but not limited to user-end interfaces/networks. User end “portals” may be termed as “customer portals” for descriptive purposes.

“Segment” or “segmentation” essentially, but not limited to, means classification according to either certain functions or segments or groups or areas-of-interest or countries or industries or type-classifications or collaboration-modes or markets or electronic-community(ies), customer-classifications, business functions or business processes or business activities or type-of-entertainment or services or solutions.

Active catalogs essentially comprise of real-time catalogs, user-requirement-configured catalogues (reverse-catalogs or “Recats”), general or conventional product/manufacture/service catalogues and catalogues that can be interactively or practically be configured to have any but not limited to combination of requirements or suppliers or products or services or other items/areas of interest.

“Customer” in terms of participants in the networked environment can mean any user-entity be it from provider-end or consumer-end or peer to peer ends. And Catalogues or Recats herein mean any compilation of general information or products/services/functions information used by users for purpose of evaluations in characteristic fashion of but not limited to shopping-lists or needs-lists or assembly-lists or bill-of-material-lists or match-lists.

Having thus described our invention, what we claim as new and desire to secure by grace of Patent is:

1) Claim, a network system and method of manufacture and assembly of Vertical Portal(s), Horizontal portal(s) and any multi-portal-system participating portal(s) using or assembling from readily available skills/products; a multi-portal system wherein end-users or participants are connected/linked or registered or interfaced at any number of portals and participate within the system as well as outside the system via the system system of integrated distributed portals with interfaces to the participants; a system of two or more distributed portals; a means for practically distributing/propagating application(s) and practical functions across the network or various portals within or outside the multi-portal system; multi-portal internally inter-linked as well as optionally externally linked/inter-linked systems/portals but not limited to the internet or intranet(s) or extra-net(s); a system for integrating/maintaining various portals to function in concert within or outside the system;

2) The system and method of claim 1 further comprising grouping or segmenting or structuring of electronic portals collaborating in the multi-portal system or in a set/system of collaborative portals included in the system of elements/portals/nodes/interfaces/functions connected/linked to the system or the network;
Vertical Portal(s) or Horizontal Portal(s) or any type of portal(s) to be included in a multi-portal or collaborative multi-portal system being created/produced and compiled as set(s) of portals individually or collectively designated by electronic location addresses as applicable within internet/intranet/extranet/other network norms and characterized by or recognizable by any consistently selected pattern of text or numerical or alphanumerical strings or characters designated as or within the electronic address or domain designation of the portal(s) or as such patterns comprised or recognizable within other addresses or domains participating in a multi-portal or collaborative multi-portal system;

3) The system and method of claim 1 further comprising creation and use of common or parts of common portal functions or contents or containers; starting with but not limited to, by prototyping/assembling/designing one or more operating hub/portal with all or a number of requisite programs/program-suites/program-modules/software-engines/functions to create a prototype portal construction or portal engine and then propagating by copying/instantiation/inheritance the construct or engine to select/individual/collective set of portals; further as may be required populating/augmenting/modifying each selected hub or portal with local/global/selective functions/interfaces; utilizing object oriented programming and/or object oriented modeling and/or common container or common content management techniques; optionally using any other programming techniques;
Optionally, propagating portal functions or engines to the portals are carried out after it has been modified/augmented/function-readied for the select/individual/collective set of portals; gateway functions/interfaces/properties/filters/processes/securities/other functions are similarily constructed/managed/provided to network participants/clients/customers/users in this multi-portal system; common OOP and OO Modeling methods utilized and augmented into the system are part of the efficiencies provided to and by the multi-portal system apparatus; this is characteristically applied to the general multi-portal system or network:

4) The system and method of claim 1 further comprising of providing any number of functions and interface(s) within or under the supervisory or controlled environment for interfaces and/or portals and/or other network(s);

5) The system of claim 1 further comprising of two or more portals constructed into an independent electronic network with options to inter-link with other internet based portal(s)/network(s) or extra-net based portal(s)/network(s) or intranet based portal(s)/network(s) or other electronic network(s) or other electronically enabled interfaces;

6) The system of claim 1 further comprising of two or more portals constructed into an independent electronic network as private or virtual private networks within the system or hybrid set of portals within the system as well as from outside the system with options to inter-link with other portals within as well as externally to other but not limited to internet based portal(s)/network(s) or extra-net based portal(s)/network(s) or intranet based portal(s)/network(s) or other electronic network(s) or other electronically enabled interfaces;

7) The practical application, of claim 1 further comprising providing a distribution apparatus for carrying out systemized, distributed functions or activities within/across/externally to the system or network such as but not limited to business functions and/or business processes and/or business activities and/or data exchange and/or data/information handling and/or function distribution and/or function handling and/or commercial exchange;

8) The system of claim 1 further comprising providing means for distributing functions and/or activities and/or traffic loads within the system or network; providing real time as well as other functionality(ies) within and across to and from other external systems;

9) CLAIM, functions provided in the multi-portal system include interfacing or utility(ies) provided to end-users in the multi-portal or network system by producing or using or assembling from readily available skills/products interactive client or end-user(s) with means to configure and manufacture products such as but not limited to portal-interfaces, customer to customer enduser interfaces, catalogues, reverse-catalogues, and hybrid-catalogues of customers/suppliers/products/client-needs/component-configuration-builders interfaces, commercial process interface(s), and other interfaces; system with selective or general automation of functions and/or processes made available to the multi-portal portals and end-users internally or externally; system and means for practically allowing providers and end-users to be linked together via a network of portals maintained in a captive or controlled or managed or a community environment (collectively or singularly hereon described as “environment”) as practically provided by any system and method of this invention; means for utilizing reverse-catalogues whereby user needs/requirements/utilization/products-of-preference are recorded and as required or facilitated are electronically configured and interfaced within or outside the environment for matching and ready reference and/or ready utilization among the environment or community or outside the environment for any utility provided or selected for/or by the user, means for providing hybrid catalogues/Recats to interface within or outside the environment with but not limited to providers of manufacture/supplies/services/functions in order to be able to build comprehensive catalogues/Recats providing any combination of any number of requirements and matches or other compilations from such as but not limited to suppliers fulfilling the requirements or providing information for catalogues/Recats

10) CLAIM, a system integrating customer/client/end-user portals with other portals providing means and functions for inter-linking with generally other customers/end-users and portals but specifically any of selected number of portals in the environment; means and functions for use of or for providing match between user requirements and/or needs and provider/supplier criteria via such as but not limited to an electronic interface which may be manually utilized or automated to provide such as but not limited to matching items/services for such as but not limited to maintenance/spares/purchase/comparison/services from various providers/suppliers or partners or preferred providers.

11) Claim 10 further comprising providing means for further active catalogue creations a system for providing various manufactures/processes/activities/functions/collaborations for use of users/persons/entities/systems/networks both within and outside the environment including but not limited to use of various levels and/or combination of possible automated functions or bots or processes within/outside the environment for such as but not limited to any or all of practical business activities/interfaces/processes/exchanges/facilities/depositories/repositories/transactions/information-handling such as but not limited to products/negotiations/purchase/order/marketing/supply-chain-management processes/client-relations management processes/transaction-processes/other processes;
